(19) United States
(12) Patent Application Publication
(10) Pub. No.: US 2006/0244878 A1
(43) Pub. Date: Nov. 2, 2006

(54) Backlight assembly and liquid crystal display apparatus having the same

(75) Inventors: Joong-Hyun Kim, Suwon-si (KR); In-Sun Hwang, Suwon-si (KR); Sang-Yu Lee, Yongin-si (KR)

Correspondence Address: David W. Heid;MacPHERSON KWOK CHEN & HEID LLP, Suite 226, 1762 Technology Drive, San Jose, CA, 95110, US

(73) Assignee: SAMSUNG ELECTRONICS CO., LTD., Suwon-si (KR)

(21) Appl. No.: 11/228,775

(22) Filed: Sep. 16, 2005

(30) Foreign Application Priority Data
Apr. 27, 2005 (KR) 2005-35139

(51) Int. Cl. G02F 1/1335

(52) U.S. Cl. 349/65

(57) ABSTRACT

A backlight assembly includes a flat fluorescent lamp, a light condensing member, a support member and a light diffusing member. The flat fluorescent lamp has a plurality of discharge spaces to generate light. The light condensing member is disposed over the flat fluorescent lamp to condense the light generated by the flat fluorescent lamp. The support member is disposed between the flat fluorescent lamp and the light condensing member to support the light condensing member. The light diffusing member is disposed over the light condensing member. Therefore, the light condensing member having a prism pattern is disposed between the light diffusing member and the flat fluorescent lamp to enhance luminance uniformity and to decrease thickness of the backlight assembly. Additionally, the support member is formed between the flat fluorescent lamp and the light condensing member to prevent the sagging of the light condensing member.

### CROSS REFERENCE TO RELATED APPLICATIONS

This application claims priority under 35 U.S.C. § 119 of Korean Patent Application No. 2005-35139, which was filed on Apr. 27, 2005 and which is hereby incorporated by reference in its entirety.

### BACKGROUND OF THE INVENTION

1. Field of the Invention

The present invention relates to a backlight assembly and a liquid crystal display apparatus including such a backlight assembly. More particularly, the present invention relates to a thinner backlight assembly with enhanced luminance capability, and a liquid crystal display apparatus including such a backlight assembly.

2. Description of the Related Art

A liquid crystal display (LCD) apparatus displays an image by controlling the optical characteristics of the liquid crystal contained in a display panel. The LCD apparatus has many merits, such as being relatively lightweight, being relatively thin, and consuming relatively low power. Therefore, the LCD apparatus is used in various applications.

The LCD apparatus includes an LCD panel and a backlight assembly which provides light to the LCD panel to display an image

A conventional backlight assembly employs one or more cold cathode fluorescent lamps (CCFLs) as light sources. However, as the size of an LCD apparatus increases, the number of the CCFLs also increases, which in turn increasesthe manufacturing cost and lowers the luminance uniformity.

To overcome the manufacturing cost and luminance uniformity problems, a flat fluorescent lamp has been developed. The flat fluorescent lamp has a plurality of discharge spaces. In these discharge spaces, ultra-violate light is generated from gas discharge when a discharge voltage that is generated by an inverter is applied. The ultraviolet light is converted into visible light by a fluorescent layer formed on an inner surface of the flat fluorescent lamp.

In the flat fluorescent lamp, dark regions are formed between the discharge spaces. These dark regions lower luminance uniformity. Therefore, to enhance luminance uniformity, a diffusion plate is provided in the backlight assembly over the flat fluorescent lamp.

Typically, luminance uniformity increases with the distance between the diffusion plate and the flat fluorescent lamp. Usually, the distance between the diffusion plate and the flat fluorescent lamp is not less than about 12 mm.

However, luminance is lowered as the distance between the diffusion plate and the flat fluorescent lamp increases, and correspondingly, the size of the backlight assembly increases. Additionally, the diffusion plate may sag.

### SUMMARY OF THE INVENTION

The present invention provides a thinner backlight assembly with an enhanced luminance capability.

The present invention also provides a liquid crystal display apparatus including such a backlight assembly.

In an exemplary backlight assembly according to the present invention, the backlight assembly includes a flat fluorescent lamp, a light condenser or condensing member, a support or support member, and a light -diffuser-or diffusing member. The flat fluorescent lamp has a plurality of discharge spaces to generate light. Supported by the support member, the light condensing member is disposed over the flat fluorescent lamp to condense the light generated by the flat fluorescent lamp. The light diffusing member is disposed over the light condensing member. A number of prisms forming a prism pattern is provided on one surface of the light condenser. In one embodiment, each prism is triangular, with an internal angle selected from a range betweem about 60° and about 120°, and a pitch (i.e., the separation between adjacent apexes of the triangular prisms) from about 10 μm to about 100 μm. For example, the light condensing member is spaced apart from the flat fluorescent lamp by the height of the support member, which may vary from about 1 mm to about 10 mm.

In an exemplary liquid crystal display apparatus according to the present invention, the display apparatus includes a backlight assembly of the type described above and a liquid crystal display panel.support member

According to the present invention, the prism pattern of the light condensing member enhances luminance uniformity and decreases the thickness of the backlight assembly.

Additionally, the support member prevents sagging of the light condensing member.

### BRIEF DESCRIPTION OF THE DRAWINGS

The above and other features and advantages of the present invention will become more apparent upon consideration of the detailed exemplary embodiments hereof, in conjunction with the accompanying drawings.

FIG. 1 is an exploded perspective view illustrating a backlight assembly, according to an exemplary embodiment of the present invention;

FIG. 2 is a cross-sectional view taken along a line I-I′ in FIG. 1;

FIG. 3 is an enlarged view illustrating a light condensing member;

FIG. 4 is a graph showing two ratios of bright region luminance to dark region luminance, each as a function of the distance ‘d’ between a flat fluorescent lamp and a prism pattern;

FIG. 5 is a cross-sectional view illustrating a light condensing member, such as the light condensing member of FIG. 1, according to another exemplary embodiment of the present invention;

FIG. 6 is a cross-sectional view illustrating a backlight assembly, according to another exemplary embodiment of the present invention;

FIGS. 7A and 7B are enlarged cross-sectional views illustrating support portions suitable for use in the backlight assemblies shown in FIGS. 2 and 6;

FIG. 8 is a cross-sectional view illustrating a backlight assembly, according to still another exemplary embodiment of the present invention;

FIG. 9 is a cross-sectional view illustrating a backlight assembly, according to still another exemplary embodiment of the present invention;

FIGS. 10A and 10B are enlarged views illustrating support portions suitable for use in the backlight assembly of FIG. 9;

FIG. 11 is an enlarged cross-sectional view illustrating a light condensing member similar to that shown in FIG. 2, shown in conjunction wth the support portions;

FIG. 12 is an enlarged cross-sectional view illustrating a light condensing member similar to that shown in FIG. 9, shown in conjunction with the support portions;

FIG. 13 is a perspective view illustrating a flat fluorescent lamp in FIG. 1;

FIG. 14 is a cross-sectional view of the flat flurescent lamp of FIG. 13, taken along a line II-II′ in FIG. 13; and

FIG. 15 is an exploded perspective view illustrating a liquid crystal display apparatus, according to an exemplary embodiment of the present invention.

### DESCRIPTION OF THE EMBODIMENTS

The exemplary embodiments of the present invention described below may be varied and modified in many different ways within the scope of the present invention. The present invention is therefore not limited by these particular embodiments described herein.

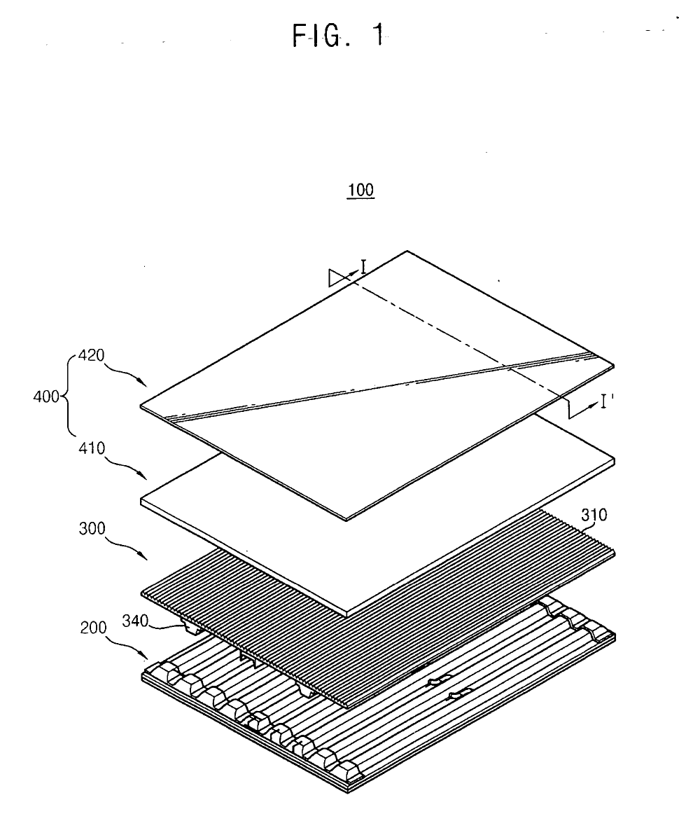

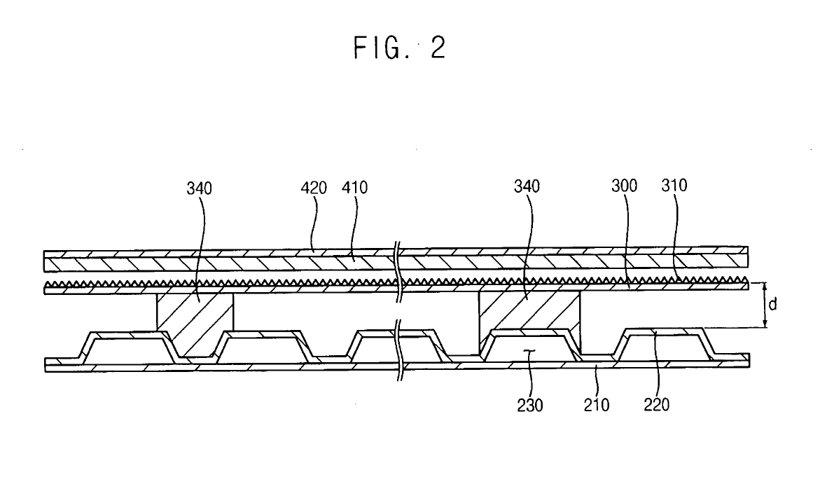

FIG. 1 is an exploded perspective view illustrating a backlight assembly according to an exemplary embodiment of the present invention, and FIG. 2 is a cross-sectional view taken along a line I-I′ in FIG. 1.

Referring to FIGS. 1 and 2, a backlight assembly 100 according to an exemplary embodiment of the present invention includes a flat fluorescent lamp 200, a light condensing member 300, a support member 340 and a light diffusing member 400.

The flat fluorescent lamp 200 includes a plurality of discharge spaces 230 which are spaced apart from each other and are divided out of the internal space of the flat fluorescent lamp 200 to enhance efficiency The flat fluorescent lamp 200 is, for example, rectangular.

The discharge spaces 230 each enclose a discharge gas. When a discharge voltage generated by an inverter (not shown) is applied to the discharge gas, ultraviolet light is generated, which is converted into visible light through a fluorescent layer (not shown) formed on an inner surface of the flat fluorescent lamp 200.

The flat fluorescent lamp 200 includes a first substrate 210 and a second substrate 220, which are attached to each other at selected positions located between the discharge spaces 230, as shown in FIG. 2.

The light condensing member 300 is disposed over the flat fluorescent lamp 200 to condense the light generated by the flat fluorescent lamp 200. The light condensing member 300 includes a prism pattern 310 facing the light diffusing member 400. Thus, the light generated from the flat fluorescent lamp 200 enters the light condensing member 300, and is refracted by the prism pattern 310 to minimize a dark region between the discharge spaces 230 and to enhance luminance uniformity. When the light exits the light condensing member 300, luminance uniformity is further enhanced by the light diffusing member 400.

The light condensing member 300 is spaced a part from the flat fluorescent lamp 200. A distance ‘d’ is created between the prism pattern 310 and the flat fluorescent lamp 200, such that the luminance measured above the discharge spaces 230 is substantially equalized with the luminance measured above the spaces between the discharge spaces 230.

An optimized distance ‘d’ between the prism pattern 310 and the flat fluorescent lamp 200 may vary according to the prism patterns 310. However, the optimized distance ‘d’ is generally less than about 10 mm. For example, the distance ‘d’ between the prism pattern 310 and the flat fluorescent lamp 200 may vary from about 3 mm to about 4 mm. Therefore, the backlight assembly 100 of the present invention is thinner, when compared with a conventional backlight assembly.

The light condensing member 300 may include an optically transparent material, such as polycarbonate (PC) or,polyethylene terephthalate (PET). The light condensing member 300 may be formed using stamping, extrusion molding, or injection molding.

The light diffusing member 400 may include a diffusion plate 410 and a diffusion sheet 420.

The diffusion plate 410 has a thickness selected from a range between about 1 mm and about 3 mm and may include an optically transparent material (e.g., polymethyl methacrylate (PMMA)), or a light diffusing agent.

The diffusion sheet 420 is thinner than the diffusion plate 410. The diffusion sheet 420 has a thickness selected from a range betwen about 50 μm and about 300 μm. The diffusion sheet 420 may include a base sheet and diffusion beads disposed on both surfaces of the base sheet.

Alternatively, the light diffusing member 400 may include only the diffusion plate 410 or the diffusion sheet 420.

The backlight assembly 100 may further include a luminance-enhancing sheet (not shown) disposed on the light diffusing member 400. For example, a dual brightness enhancement film (DBEF) may be employed as the luminance-enhancing sheet.

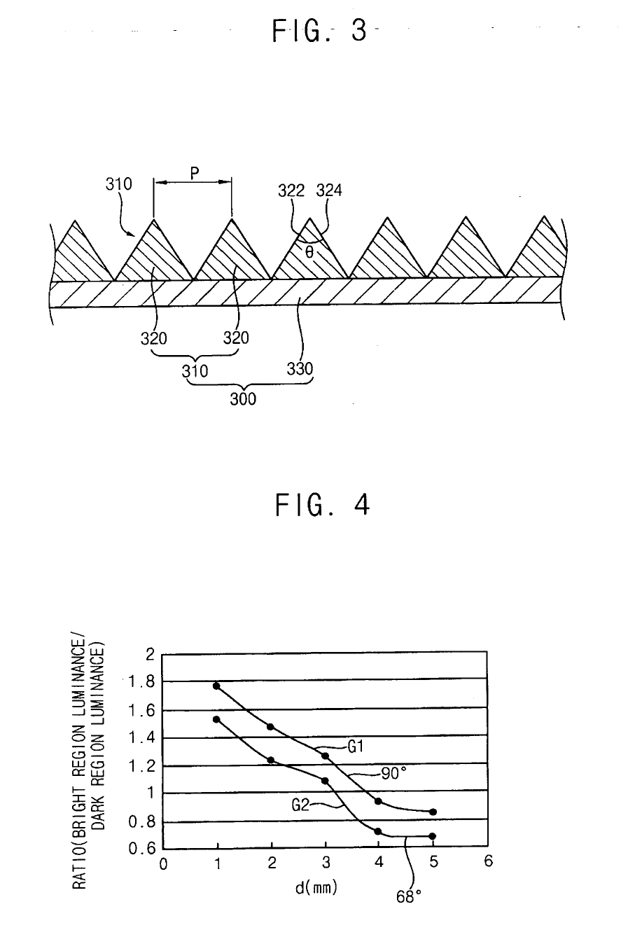

FIG. 3 is an enlarged view illustrating a light condensing member 300.

Referring to FIGS. 2 and 3, the light condensing member 300 includes a transparent film 330 and a prism pattern 310 formed on a surface of the transparent film 330.

The transparent film 330 is relatively thin (e.g., having a thickness from about 50 μm to about 300 μm) and includes an optically transparent material in order to prevent light loss.

The prism pattern 310 is formed on an upper surface 330 of the transparent film 330, which faces the light diffusing member 400. The prism pattern 310 may be formed, for example, using the same material as the transparent film 330. The prism pattern 310 may be integrally formed with the transparent film 330. The prism pattern 310 includes prisms placed adjacent each other. The prisms may have one of various shapes.

For example, each prism inthe prisms 320 may include a first inclined face 322 and a second inclined face 324 meeting at an angle θ, which is selected from a range between about 60° and about 120°. A suitable pitch (or an interval) ‘P’ between adjacent prisms may be selected from about 10 μm to about 100 μm.

FIG. 4 is a graph showing two ratios of luminances between a bright region and a dark region, each as a function of the distance ‘d’ between the flat fluorescent lamp and the prism pattern. The bright region luminance corresponds to the luminance measured over the discharge spaces, and the dark region luminance corresponds to the luminance measured over the region between the discharge spaces. In FIG. 4, a first graph G1 corresponds to a prism pattern in which each prism has an angle θ of about 90° and a pitch ‘P’ of about 50 μm, and the second graph G2 corresponds to a prism pattern in which each prism has an angle θ of about 68° and a pitch ‘P’ of about 50 μm.

Referring to FIG. 4, the ratios of bright region luminance to a dark region luminance in graphs G1 and G2 are measured by changing the distance ‘d’ between the flat fluorescent lamp and the prism pattern.

As seen in graphs G1 and G2, when the distance ‘d’ between the flat fluorescent lamp and the prism pattern increases, the ratio of bright region luminance to a dark region luminance decreases.

When the ratio of the bright region luminance to the dark region luminance approaches one, the corresponding distance ‘d’ between the flat fluorescent lamp and the prism pattern is optimized. According to graph G1, the optimum distance ‘d’ between the flat fluorescent lamp and the prism pattern is in a range of about 3 mm to about 4 mm. According to graph G2, the optimum distance ‘d’ between the flat fluorescent lamp and the prism pattern is about 3 mm. Therefore, in a backlight assembly that includes a prism pattern in which the angle θ of a prism is about 68° and the pitch ‘P’ between adjacent prisms is about 50 μm, luminance uniformity is optimized when the distance between the prism pattern and the flat fluorescent is about 3 mm.

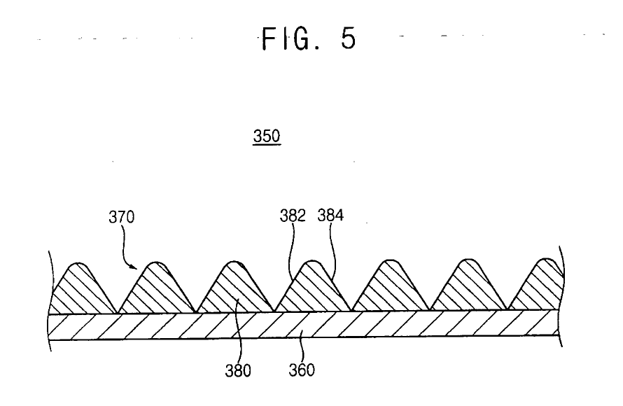

FIG. 5 is a cross-sectional view illustrating a light condensing member in FIG. 1 according to another exemplary embodiment of the present invention.

Referring to FIG. 5, a light condensing member 350 according to another exemplary embodiment of the present invention includes a transparent film 360 and prism pattern 370 formed on a surface of the transparent film 360.

The prisms in prism pattern 370 are adjacent to each other. Each of the prisms in prism pattern 370 may be provided one of various shapes. As shown in FIG. 5, each prism of the prism pattern 370 includes a first inclined face 382 and a second inclined face 384. The first and second inclined faces 382 and 384 meet at a rounded portion. Therefore, when the light diffusing member 400 is disposed on the prism pattern 370, deformation of the prism pattern 370 is prevented. The light condensing member 350 of the present embodiment is substantially the same as the light condensing member 350 in FIG. 3 except for the rounded portion. Thus, a further detailed description of a backlight assembly using the light condensing member 350 of FIG. 5 is omitted to avoid repetition.

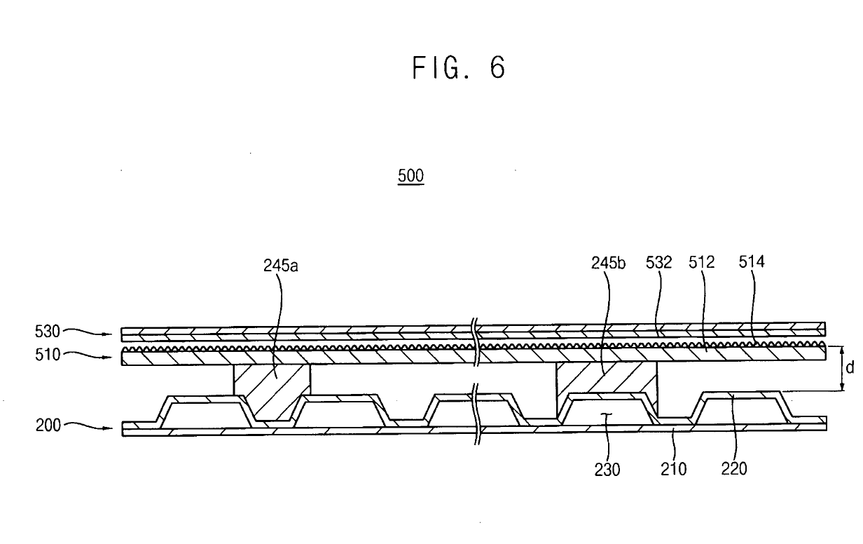

FIG. 6 is a cross-sectional view illustrating a backlight assembly according to another exemplary embodiment of the present invention. The flat fluorescent lamp according to the present embodiment is substantially the same as the flat fluorescent lamp shown in FIG. 2. Thus, the same reference numerals are used to refer to the same or like elements as those described in FIG. 2, and any further detailed description concerning these elements is omitted.

Referring to FIG. 6, a backlight assembly 500 according to the present embodiment includes a flat fluorescent lamp 200, a light condensing member 510 and a light diffusing member 530.

The light condensing member 510 is disposed over and spaced apart from the flat fluorescent lamp 200. The light condensing member 510 includes a transparent plate 512 and a prism pattern 514 formed on a surface of the transparent plate 512.

The transparent plate 512 includes an optically transparent material to prevent light loss. The transparent plate 512 has, for example, a thickness of about 1 mm to about 3 mm.

The prism pattern 514 is formed on an upper surface of the transparent plate 512 facing the light diffusing member 530. In other words, the prism pattern 514 is formed on a surface through which light that is generated from the flat fluorescent lamp 200 exits from the transparent plate. Each of the prism in the prism pattern 514 is triangular. The prism pattern 514 has substantially the same structure as one of the prism patterns shown in FIGS. 3 and 5. Thus, any further detailed description of the prism pattern 514 is omitted.

A distance ‘d’ between the prism pattern 514 and the flat fluorescent lamp 200 is adjusted such that the luminance measured over the discharge spaces 230 is substantially equalized with the luminance measured over a region between the discharge spaces 230.

An optimized distance ‘d’ between the prism pattern 514 and the flat fluorescent lamp 200 may vary with the shape of the prism pattern 514. However, the optimized distance ‘d’ is generally less than about 10 mm (e.g., from about 3 mm to about 4 mm).

The light diffusing member 530 is disposed over the light condensing member 510. The light diffusing member 530 diffuses light that exits from the light condensing member 510 to enhance luminance uniformity.

The light diffusing member 530 includes at least one diffusion sheet 532. For example, the light diffusing member 530 of FIG. 6 includes two diffusion sheets.

In FIG. 6, each diffusion sheet (e.g., diffusion sheet 532) is about 50 μm to about 300 μm thick. Each diffusion sheet includes a base sheet, with diffusion beads disposed on both surfaces of the base sheet.

Alternatively, the light diffusing member 400 of FIG. 1 includes only the diffusion plate 410 and the diffusion sheet 420.

The backlight assembly 500 may further include a diffusion plate (not shown). Additionally, the backlight assembly 500 may further include a luminance-enhancing sheet, such as a dual brightness enhancement film (DBEF).

Table 1 below shows front-view luminances according to various combinations of light condensing members and light diffusing members.

TABLE 1

| | Combination of the light condensing member | Front-view |
|---|---|---|
| | and the light diffusing member | luminance (nt) |
| Example 1 | DP | 4494 |
| Example 2 | DP + DS | 5507 |
| Example 3 | PS + DP | 4671 |
| Example 4 | PS + DS + DS | 7533 |
| Example 5 | PS + DS + DS + DS | 6923 |

In Table 1,
“DP” represents a diffusing plate,
“DS” represents a diffusion sheet, and
“PS” represents a light condensing member.

Referring to Table 1, the front-view luminances of Examples 3, 4 and 5 each employing a light condensing member ‘PS’ are substantially higher than corresponding front-view luminances of Examples 1 and 2 without employing a light condensing member. This is because the prism pattern of the light condensing member increases the light intensity reaching the diffusing member In a backlight assembly employing the light condensing member ‘PS’, the front-view luminance employing the diffusion sheet ‘DS’ (e.g., in each of Examples 4 and 5) is higher than the front-view luminance employing the diffusion plate ‘DP’ (e.g., Example 3). Additionally, the front-view luminance employing two diffusion sheets ‘DS’ (e.g., Example 4) is higher than the front-view luminance employing three diffusion sheets ‘DS’ (e.g., Example 5).

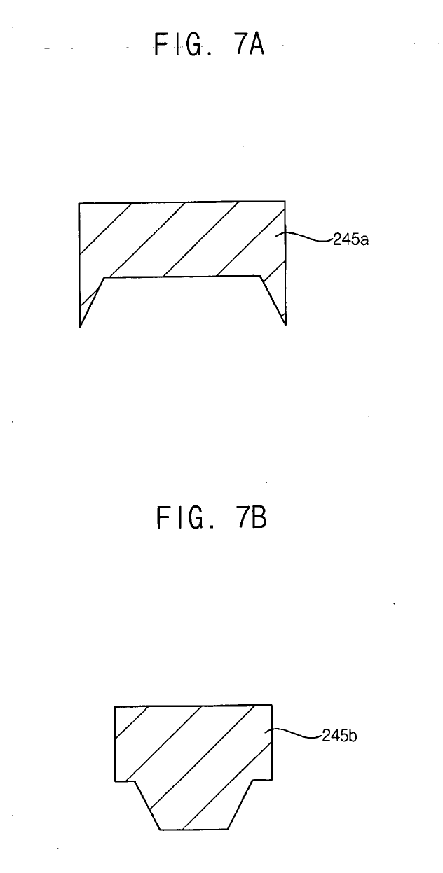

FIGS. 7A and 7B show enlarged cross-sectional views of the support portions shown in FIGS. 2 and 6.

Referring to FIGS. 6, 7A and 7B, the shapes of support portions 245a and 245b are provided according to their respective positions. For example, support portion 245a in FIG. 7A is adapted for being disposed over the discharge spaces. The support portion 245a is, for example, cylindrical, having a diameter of about 2 mm and a height of about 2 mm. The support portion 245b in FIG. 7B is adapted for being disposed over a space between the discharge spaces. The support portion 245b is, for example, cylindrical, having a diameter of about 2 mm and a height of about 4.3 mm. The light path may be changed due to the support portions 245a and 245b. However, the supporting portions shown in FIGS. 7A and 7B are adapted to minimize the change in the light path.

Heights of the support portions 245a and 245b are adjusted according to the optimized distance between the flat fluorescent lamp and the light condensing member (i.e, the heights of the support portions 245a and 245b are adjusted to maximize luminance uniformity). For example, as the angle of the prism increases, the height of the support portions 245a and 245b decreases, and vice versa.

The support portions 245a and 245b have the same index of refraction as the light condensing member. For example, the support portion 245a and 245b may be made from the same material as the condensing member. Support portions may be provided at one or more center positions and also provided between the center positions and the periphery at uniform intervals.

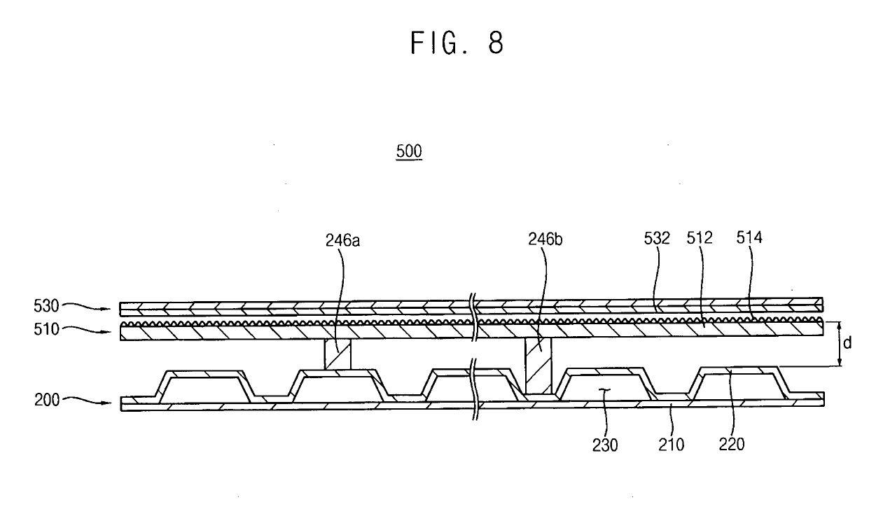

FIG. 8 is a cross-sectional view illustrating a backlight assembly according to still another exemplary embodiment of the present invention. The backlight assembly of the present embodiment is the same as those shown in FIGS. 2 and 6, except that the support portions have different shapes. Thus, the same reference numerals are used to refer to the same or like elements as those described in FIGS. 2 and 6 and any further detailed description concerning those elements is omitted.

Referring to FIG. 8, a backlight assembly according to the present embodiment includes a first support portion 246a and a second support portion 246b. Each of support portions 246a and 246b may be cylindrical, for example. Alternatively, the support portions 246a and 246b may be each a polygonal prism. The support portions 246a and 246b support a light condensing member 510. The support portion 246a is disposed over the discharge spaces 230 and the support portion 246b is disposed between the discharge spaces 230, so that the support portion 246b is longer than the support portion 246a by an amount that is substantially the same as the height of the discharge space 230.

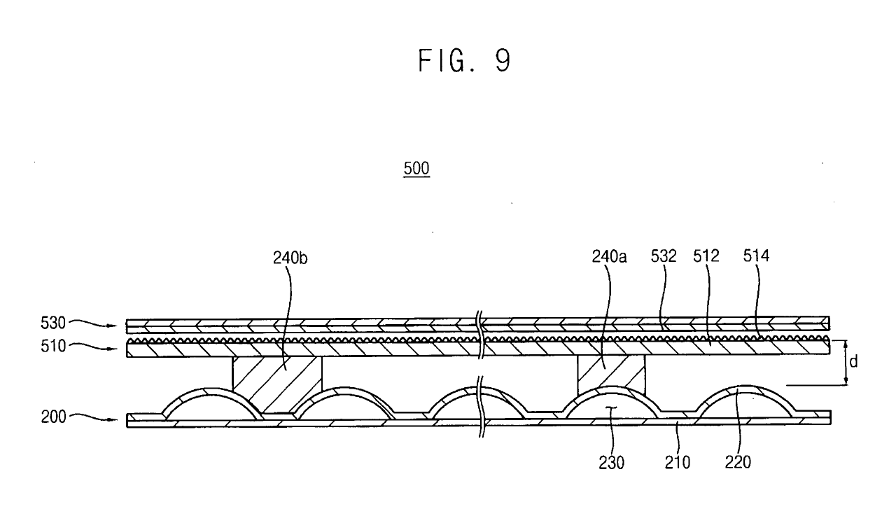

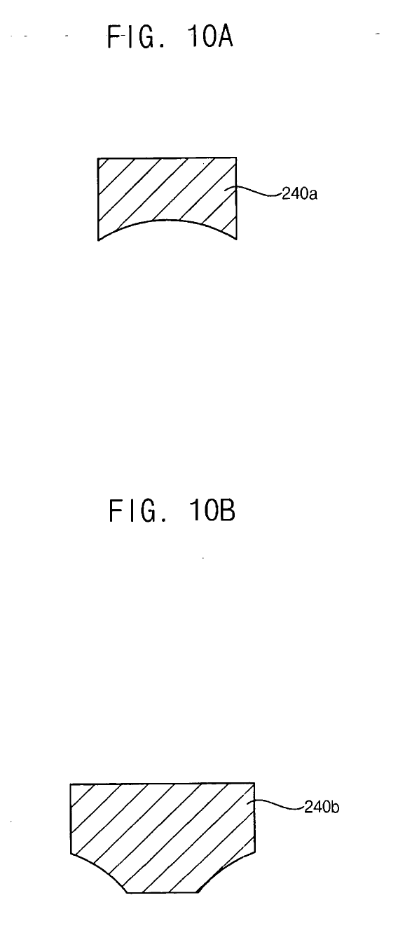

FIG. 9 is a cross-sectional view illustrating a backlight assembly according to still another exemplary embodiment of the present invention. FIGS. 10A and 10B are enlarged views illustrating the support portions shown in FIG. 9. The backlight assembly of FIG. 9 is the same as those shown in FIGS. 2 and 6, except for the shapes of the support portions. Thus, the same reference numerals are used to refer to the same or like elements as those described in FIGS. 2 and 6 and any further detailed description concerning those elements is omitted.

Referring to FIGS. 9, 10A and 10B, the cross section of each of the discharge spaces 230 of the flat fluorescent lamp 200 has the shape of an arch. Therefore, the shapes of the bottom portions of support portion 340a and support portion 340b are curved according to the arch-shaped surfaces of the flat fluorescent lamp 200.

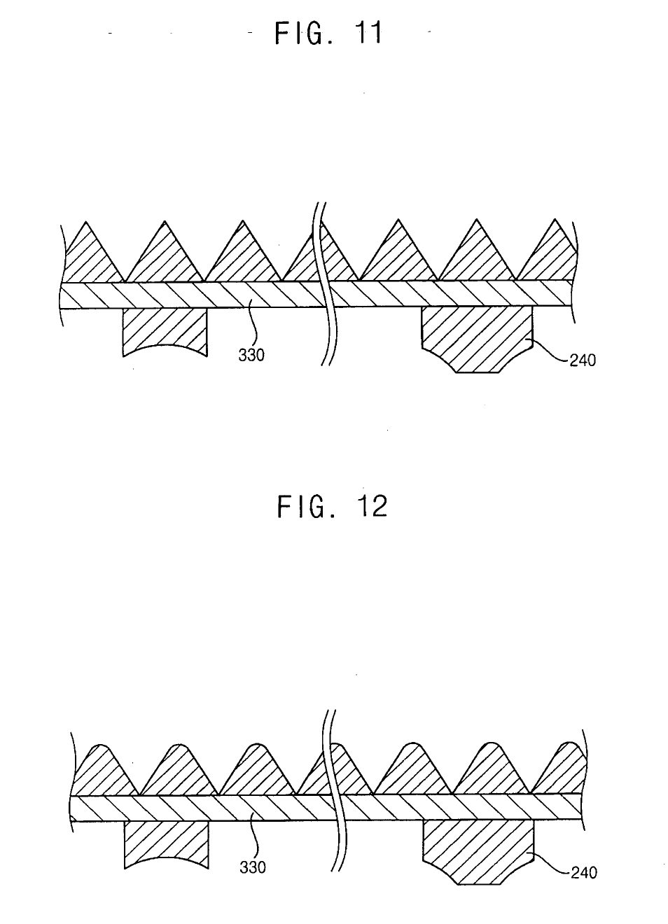

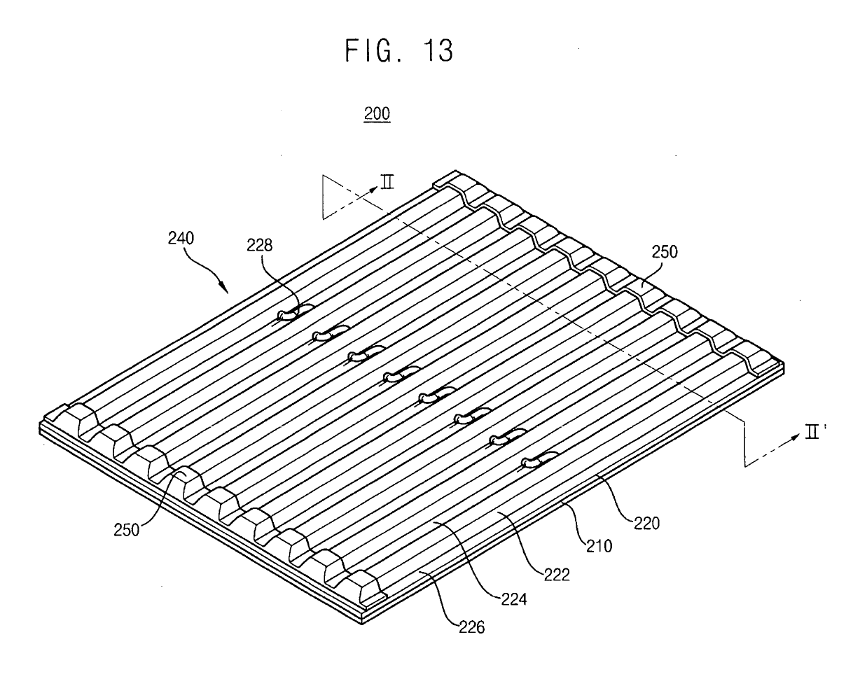

FIG. 11 is an enlarged cross-sectional view illustrating a light condensing member similar to that shown in FIG. 2, shown in conjunction with the support portions. FIG. 12 is an enlarged cross-sectional view illustrating a light condensing member similar to that shown in FIG. 9, shown in conjunction with the support portions.

Referring to FIGS. 11 and 12, the support portions are integrally formed with the light condensing member. Integrally forming the support portions with the light condensing member facilitates assemblage of the backlight assembly.

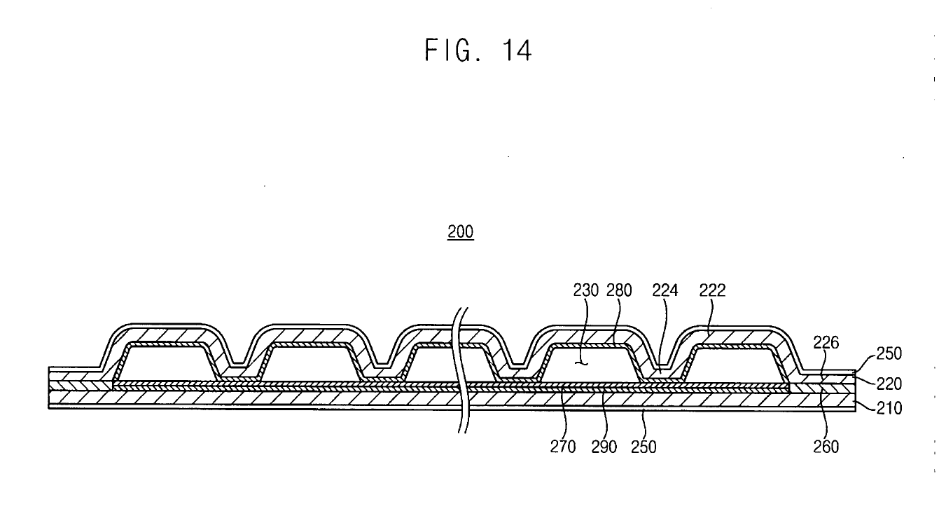

FIG. 13 is a perspective view illustrating a flat fluorescent lamp in FIG. 1, and FIG. 14 is a cross-sectional view of the flat fluorescent lamp taken along a line II-II′ in FIG. 13.

Referring-to FIGS. 13 and 14, the flat-fluorescent lamp 200 includes a lamp body 240 and a pair of electrodes 250. The lamp body 240 includes a plurality of discharge spaces 230 arranged in a parallel configuration with each other. The electrodes 250 are disposed at end portions of the lamp body 240, substantially perpendicular to the discharge spaces 230.

The lamp body 240 includes a first substrate 210 and a second substrate 220, which are are combined with each other at predetermined positions to form the discharge spaces 230.

The first substrate 210 is rectangular, and may be made of a material that includes, for example, glass. The first substrate 210 may also include an ultraviolet light blocking material in order to prevent leakage of ultraviolet light.

The second substrate 220 has a plurality of furrows that form the discharge spaces 230. The second substrate 220 is optically transparent to visible light. The second substrate 220 also may include an ultraviolet light blocking material in order to prevent leakage of ultraviolet light.

The furrows of the second substrate 220 may be formed using one of various methods. For example, a flat plate may be heated and compressed according to a molding pattern. Alternatively, air may be blown onto the heated flat plate to form the furrows.

As shown in FIGS. 13 and 14, the second substrate 220 includes discharge space portions 222, space dividing portions 224 and sealing portion 226. The discharge space portions 222 are spaced apart from the first substrate 210 to define the discharge spaces 230, when the first and second substrates 210 and 220 are combined with each other. Each of the space dividing portions 224 is disposed between two discharge space portions 222 adjacent to each other, and the space dividing portions 224 make contact with the first substrate 210 when the first and second substrates 210 and 220 are combined with each other. The sealing portion 226 is disposed at edge portions of the second substrate 220. The first and second substrates 210 and 220 are combined with each other through the sealing portion 226.

Each of the discharge portions 222 are arch-shaped. Alternatively, each of the discharge portions 222 may have one of various shapes, such as semi-circular, rectangular, or trapezoidal.

The second substrate 220 includes connection paths 228, which connect adjacent discharge spaces 230 to each other. At least one connection path 228 is disposed at each space diving portion 224. Injected discharge gas may pass through the connection path 228 to expel air from discharge spaces 230. The connection path 228 may be formed in the same process for forming the second substrate 220. The connection path 228 may have one of various shapes (e.g., an S-shape). When the length of the connection path 228 increases, an interference between the discharge spaces 230 is reduced to prevent a channeling effect that induces deterioration.

The first and second substrates 210 and 220 are combined with a sealing member 260, such as a frit made from a glass and a metal and which has a lower melting point than the glass. The frit, which is disposed between the first and second substrates 210 and 220 at the sealing portion 226, is melted by heat in order to combine the first and second substrates 210 and 220. The combining process is performed at a temperature of about 400° C. to about 600° C.

The space diving portions 224 of the second substrate 220 are held in contact with the first substrate 210 by a pressure difference between atmosphere and discharge spaces 230. When the first and second substrates 210 and 220 are combined with each other, air in the discharge spaces 230 is expelled, and then a discharge gas (e.g., mercury (Hg), neon (Ne), argon (Ar)) is injected into the discharge spaces 230 until the pressure in the discharge spaces 230 reaches a range of about 50 Torr to about 70 Torr. (The atmospheric pressure is about 760 Torr.).

The lamp body 200 further includes a first fluorescent layer 270 and a second fluorescent layer 280. The first fluorescent layer 270 is formed on an inner surface of the first substrate 210, and the second fluorescent layer 280 is formed on an inner surface of the second substrate 220. The first and second substrates 270 and 280 convert ultraviolet light generated by the discharge gas into visible light.

The lamp body 200 further includes a light reflecting layer 290 disposed between the first substrate 210 and the first fluorescent layer 270. The light reflecting layer 290 reflects visible light toward the second substrate 220 to prevent leakage of the visible light. The light reflecting layer 290 enhanced reflectivity and reduces a change of color. The light reflecting layer 290 includes a metal oxide, such as aluminum oxide (Al₂O₃) or barium sulfate (BaSO₄).

The first fluorescent layer 270, the second fluorescent layer 280 and the light reflecting layer 290 are formed, for example, using a spraying method before the first and second substrates 210 and 220 are combined with each other. The first fluorescent layer 270, the second fluorescent layer 280 and the light reflecting layer 290 are formed on all portions of the inner face except for the sealing portion 226. Alternatively, the first fluorescent layer 270, the second fluorescent layer 280 and the light reflecting layer 290 are not formed in the space dividing portions 224.

The lamp body 200 may also include a protection layer (not shown) interposed between the first substrate 210 and the light reflecting layer 290. A protection layer may also be interposed between the second substrate 220 and second fluorescent layer 280. The protection layer prevents a chemical reaction between mercury in the discharge gas and the glass of the first and second substrates 210 and 220, so that mercury loss and blackening of the first and second substrates 210 and 220 are prevented.

The electrodes 250 are disposed at the ends of the lamp body 240. The electrodes 250 overlap all discharge spaces 230 and are disposed on an outer surface of the second substrate 220. The flat fluorescent lamp 200 may include additional electrodes formed on an outer surface of the first substrate 210. The flat fluorescent lamp 200 may then further include a conducting clip (not shown) that electrically connects one of the electrodes 250 disposed on the outer face of the second substrate 220 with the electrode disposed on the outer surface of the first substrate 210. The electrodes 250 may be disposed in the lamp body 240.

The electrode 250 are conductive so as to apply electrical power provided by the inverter board 400 in FIG. 2 to the lamp body 240. Silver paste, such as that including silver (Ag) and silicon oxide (SiO₂), may be coated on the outer face of the lamp body 240 to form the electrodes 250. A metal powder may be coated using a spray coating method to form the electrodes 250. An insulating layer (not shown) may be formed on the electrodes 250 to protect the electrode 250.

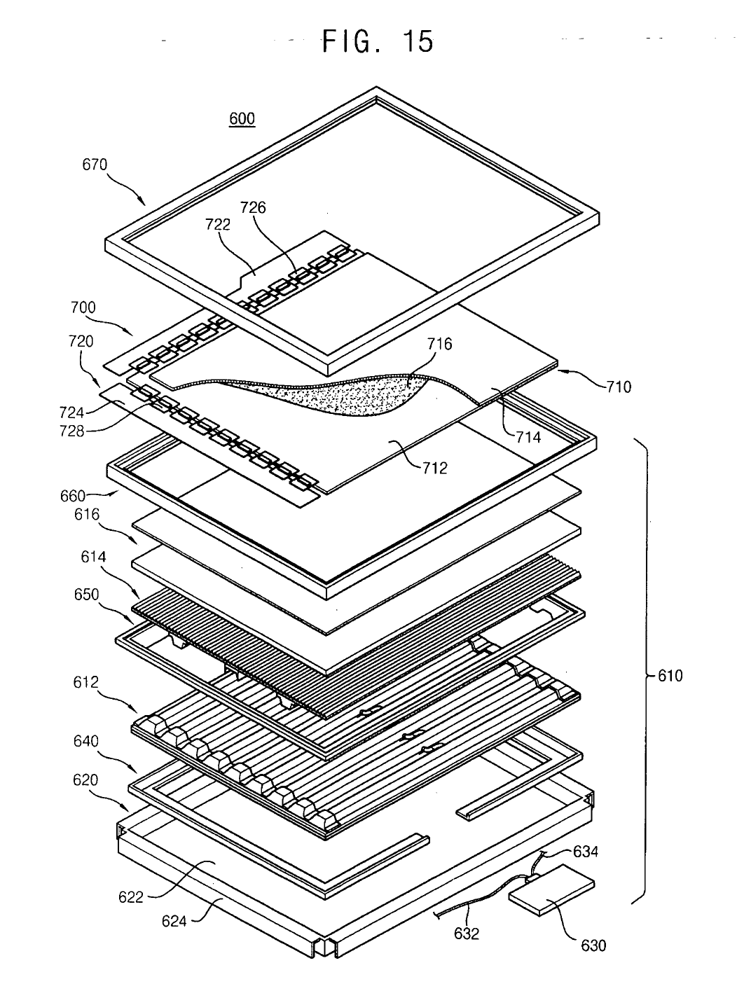

FIG. 15 is an exploded perspective view illustrating a liquid crystal display apparatus according to an exemplary embodiment of the present invention.

Referring to FIG. 15, a liquid crystal display (LCD) apparatus 600 according to the present embodiment includes a backlight assembly 610 and a display unit 700. The display unit 700 displays an image using the light provided by the backlight assembly 610.

The backlight assembly 610 includes a flat fluorescent lamp 612, a light condensing member 614 and a light diffusing member 616. The backlight assembly 610 of the present embodiment may be any of the backlight assemblies described above in conjunction with FIGS. 1 to 12. Thus, any further detailed description concerning such backlight assemblies is omitted.

The backlight assembly 610 further includes a receiving container 620 and an inverter 630. The receiving container 620 receives the flat fluorescent lamp 612. The inverter 630 generates discharge voltage that is applied to the flat fluorescent lamp 612.

The receiving container 620 includes a bottom plate 622 and sidewalls 624. The sidewalls 624 extend from edge portions of the bottom plate 622 to define a receiving space. The sidewalls 624 may be bent such that a cross section of the sidewalls 624 is U-shaped. In detail, each of the sidewalls 624 includes a first portion, a second portion and a third portion. The first portion is upwardly extended from t he edge portions of the bottom plate 622. The second portion is extended from the first portion such that the second portion is substantially in parallel with the bottom plate 622. The third portion is extended downwardly from the second portion such that the third portion is substantially in parallel with the second portion. The receiving container 620 may be for example, metallic.

The backlight assembly 610 may also include a first mold 650. The first mold 650 is disposed between the flat fluorescent lamp 200 and the light condensing member 614. The first mold 650 fixes edge portions of the flat fluorescent lamp 200 and supports edge portions of the light condensing 614 and the light diffusing member 616. The first mold 650 has a frame shape. Alternatively, the first mold 650 may be formed in two inverted U-shaped pieces or four L-shaped pieces.

The backlight assembly 610 may further include a second mold 660. The second mold 660 is disposed between the light diffusing member 616 and the display unit 700. The second mold 660 fixes edge portions of the light diffusing member 616 and the display unit 700. The second mold 660 further supports edge portions of an LCD panel 710. The second mold 660 has a frame shape. Alternatively, the second mold 660 may be formed in two inverted U-shape pieces or four L-shape pieces.

The display unit 710 includes the LCD panel 710 for displaying an image and a driver circuit part 720 for driving the LCD panel 710.

The LCD panel 710 includes an array substrate 712, a color filter substrate 714 that is combined with the array substrate 712, and a liquid crystal layer 716 disposed between the array substrate 712 and the color filter substrate 714.

The array substrate 712 includes a plurality of thin film transistors (TFTs) arranged in a matrix. Each of the TFTs includes a gate electrode that is electrically connected to one of gate lines, a source electrode that is electrically connected to one of data lines, and a drain electrode that is electrically connected to a pixel electrode including an optically transparent and electrically conductive material.

The color filter substrate 714 includes red color filters ‘R’, green color filters ‘G’ and blue color filters ‘B’. The color filter substrate 714 may further include a common electrode including an optically transparent and electrically conductive material.

When a gate voltage is applied to the gate electrode of the TFT, the TFT is turned on, so that data voltage is applied to the pixel electrode through the TFT. When the data voltage is applied to the pixel electrode, electric fields are generated between the pixel electrode and the common electrode-to alter an orienteation of the liquid crystal molecules in the liquid crystal layer 716. When the orientation of the liquid crystal molecules is altered, optical transmissivity of the liquid crystal layer 716 is changed, so as to display an image when the light generated from the backlight assembly 610 passes through the liquid crystal layer 716.

The driver circuit part 720 includes a data printed circuit board (data PCB) 722, a gate printed circuit board (gate PCB) 724, a data flexible printed circuit (data FPC) 726 and a gate flexible printed circuit (gate FPC) 728. The data PCB 722 provides the LCD panel 710 with a data driving signal. The gate PCB 724 provides the LCD panel 710 with a gate driving signal. The data FPC 726 connects the data PCB 722 to the LCD panel 710. The gate FPC 728 connects the gate PCB 724 to the LCD panel 710.

A tape carrier package (TCP) or a chip-on-film (COF) may be employed as the data and gate FPCs 726 and 728. When the LCD panel 710 includes a gate driving circuit, the gate PCB 724 and the gate FPC 728 are not required.

The LCD apparatus 600 further includes a top chassis 670 for fixing the display unit 700. The top chassis 670 is combined with the receiving container 620 to fix the LCD panel 710. The data FPC 726 is bent, so that the data PCB 722 is disposed at a side of the receiving container 620 or a bottom of the receiving container 620. The top chassis 670 includes a metal having relatively high strength.

According to the backlight assembly and the LCD apparatus of the present invention, the light condensing member having a prism pattern is disposed between the light diffusing member and the flat fluorescent lamp to enhance luminance uniformity and to decrease thickness of the backlight assembly.

Additionally, a support member is provided between the flat fluorescent lamp and the light condensing member to prevent sagging of the light condensing member.

Having described the exemplary embodiments of the present invention and its advantages, it is noted that various changes, substitutions and alterations can be made within the scope of the present invention, which is defined by the appended claims.

What is claimed is:

1. A backlight assembly comprising:
a flat fluorescent lamp having a plurality of discharge spaces to generate light;
a light condensing member disposed over the flat fluorescent lamp to condense the generated light;
a support member that is disposed between the flat fluorescent lamp and the light condensing member to support the light condensing member; and
a light diffusing member disposed over the light condensing member.

2. The backlight assembly of claim 1, wherein the light condensing member comprises a prism pattern.

3. The backlight assembly of claim 2, the light condensing member further comprises a transparent film on a surface of which the prism pattern is formed.

4. The backlight assembly of claim 2, wherein the light condensing member further comprises a transparent plate on a surface of which the prism pattern is formed.

5. The backlight assembly of claim 2, wherein the prism pattern includes triangular prisms each having an angle of about 60° to about 120°, and a pitch of the prism pattern is in a range of about 10 μm to about 100 μm.

6. The backlight assembly of claim 5, wherein the light condensing member is spaced apart from the flat fluorescent lamp by a distance of about 1 mm to about 10 mm.

7. The backlight assembly of claim 2, wherein each of the prism pattern has triangular prisms each having an angle of about 90°, and a pitch of the prism pattern is about 50 μm.

8. The backlight assembly of claim 7, wherein the light condensing member is spaced apart from the flat fluorescent lamp by a distance of about 3 mm to about 4 mm.

9. The backlight assembly of claim 2, wherein the prism pattern has triangular prisms each having a rounded edge.

10. The backlight assembly of claim 1, wherein the support member is integrally formed with the light condensing member.

11. The backlight assembly of claim 1, wherein the light diffusing member comprises a diffusion plate.

12. The backlight assembly of claim 1, wherein the light diffusing member comprises at least one diffusion sheet.

13. The backlight assembly of claim 1, wherein the flat fluorescent lamp comprises:
a lamp body having the discharge spaces spaced apart from each other; and
an electrode formed at an end portion of the lamp body substantially perpendicular to the discharge spaces.

14. The backlight assembly of claim 13, wherein the lamp body comprises:
a first substrate; and
a second substrate that is combined with the first substrate at predetermined positions of the first substrate, the second substrate comprising:
a shape for forming plurality of discharge spaces spaced apart from the first substrate;
a plurality of space dividing portions which make contact with the first substrate; and
a sealing portion at an edge portion of the second substrate, the first and second substrates being combined with each other by the sealing portion.

15. A liquid crystal display (LCD) apparatus comprising:
a backlight assembly that generates light, including:
a flat fluorescent lamp having a plurality of discharge spaces to generate light;
a light condensing member disposed over the flat fluorescent lamp to condense the light generated by the flat fluorescent lamp;
a support member that is disposed between the flat fluorescent lamp and the light condensing member to support the light condensing member; and
a light diffusing member disposed over the light condensing member; and
a liquid crystal display panel disposed over the backlight assembly, the liquid crystal display panel displaying an image using the light generated from the backlight assembly.

16. The LCD apparatus of claim 15, wherein the light condensing member comprises a prism pattern.

17. The LCD apparatus of claim 16, wherein the prism pattern includes triangular prisms each having an angle of about 60° to about 120°, and a pitch of the prism pattern is in a range of about 10 μm to about 100 μm.

18. The LCD apparatus of claim 17, wherein the light condensing member is spaced apart from the flat fluorescent lamp by a distance of about 1 mm to about 10 mm.

19. The LCD apparatus of claim 15, wherein the support member is integrally formed with the light condensing member.

20. The LCD apparatus of claim 15, wherein the backlight assembly further comprises:
a receiving container that receives the flat fluorescent lamp; and
an inverter that generates a discharge voltage that is applied to the flat fluorescent lamp.

21. The LCD apparatus of claim 20, wherein the backlight assembly further comprises:
an insulation member disposed between the flat fluorescent lamp and the receiving container to support the flat fluorescent lamp;
a first mold that is disposed between the flat fluorescent lamp and the light condensing member to fix the light condensing member to the flat fluorescent lamp; and
a second mold that is disposed between the light diffusing member and the liquid crystal display panel to support the liquid crystal display panel.
